(19) United States
(12) Patent Application Publication
(10) Pub. No.: US 2026/0177450 A1
(43) Pub. Date: Jun. 25, 2026

(54) TEST DEVICE FOR SEALING MATERIAL UNDER COMPLEX VIBRATION

(71) Applicant: Tsinghua University, Beijing (CN)

(72) Inventors: Fei Guo, Beijing (CN); Yijie Huang, Beijing (CN); Pengbing Wang, Beijing (CN)

(21) Appl. No.: 19/052,560

(22) Filed: Feb. 13, 2025

(30) Foreign Application Priority Data
Dec. 23, 2024 (CN) 202411905941X

(51) Int. Cl. G01M 7/06; B06B 3/00

(52) U.S. Cl. CPC G01M 7/06; B06B 3/00

(57) ABSTRACT

The present application relates to the field of test devices, and in particular to a test device for sealing material under complex vibration. The test device includes a test body, a vibration component, and a test assembly. The test body includes a test cylinder and a cover body, where a test cavity is provided inside the test cylinder, the cover body is used to close the test cavity, and a seal to be tested is provided between the cover body and the test cylinder; the vibration component includes a vibration platform and a multi-stage vibration mechanism, where the vibration platform is suitable for being fixed to a preset mount position, the test cylinder is embedded in the vibration platform, the multi-stage vibration mechanism is connected to the vibration platform, and is suitable for simulating multi-stage vibration conditions by driving the test cylinder through the vibration platform; and the test assembly includes sensors and a control component, where the sensors are electrically connected to the control component, and the sensors are used to monitor sealing performance of the test cavity and feed back corresponding monitored information to the control component. The test device may be used to simulate use states of a seal under complex working conditions to verify the reliability and stability of the seal under complex vibration conditions.

### FIELD

The present application relates to the field of test devices, and in particular to a test device for sealing material under complex vibration.

### BACKGROUND

A seal, as one of the most important basic elements in engineering and manufacturing industry, plays an irreplaceable role in many industries and application scenarios. The seal is usually made of elastic materials, such as rubber, polyurethane, silicone, etc. The seal is elastic and flexible and may adapt to different surface shapes and motion states, and maintain good sealing performance. The seal is mainly used to prevent the leakage of a fluid (liquid or gas), dust and other impurities while preventing the intrusion of external media.

For special seals used in hydrogen gas application scenarios, it is necessary to consider sealing performance of the seal under multi-stage vibration working conditions. However, there is a lack of a commercially available test device that may effectively simulate the performance of the seal in hydrogen gas application scenarios, which will directly affect the reliability and safety of equipment in hydrogen gas application scenarios, especially for industries that rely on high-purity hydrogen operations, such as aerospace, nuclear energy, fine chemicals, and on-board hydrogen storage.

### BRIEF SUMMARY

The present application provides a test device for sealing material under complex vibration, which solves defects mentioned above in the related art, and may be used to simulate use states of a seal under complex working conditions to verify the reliability and stability of the seal under complex vibration conditions.

The present application provides a test device for sealing material under complex vibration, including a test body, a vibration component and a test assembly.

The test body includes a test cylinder and a cover body, a test cavity is provided inside the test cylinder, the cover body covers the test cylinder to close the test cavity, and a seal to be tested is provided between the cover body and the test cylinder;
the vibration component includes a vibration platform and a multi-stage vibration mechanism, the vibration platform is suitable for being fixed to a preset mount position, the test cylinder is embedded in the vibration platform, the multi-stage vibration mechanism is connected to the vibration platform, and is suitable for simulating multi-stage vibration conditions by driving the test cylinder through the vibration platform; and
the test assembly includes sensors and a control component, the sensors are electrically connected to the control component, and the sensors are used to monitor sealing performance of the test cavity and feed back corresponding monitored information to the control component.

According to the test device for performance of the seal under multi-stage vibration provided by the present application, the multi-stage vibration mechanism includes a drive assembly, a rotation assembly, a first vibration assembly and a second vibration assembly; and
the rotation assembly is connected to the test cylinder to drive the test cylinder to rotate, the first vibration assembly is suitable for abutting against the test cylinder to drive the test cylinder to vibrate in a vertical direction, the second vibration assembly is suitable for abutting against the test cylinder to drive the test cylinder to swing in a horizontal direction, the drive assembly is connected to any one of the rotation assembly, the first vibration assembly and the second vibration assembly, and is used to drive the rotation assembly, the first vibration assembly and the second vibration assembly to perform staged vibration.

According to the test device for performance of the seal under multi-stage vibration provided by the present application, the rotation assembly includes a rotary shaft, a first rotary teeth-uncompleted gear, a second rotary teeth-uncompleted gear, a first transmission gear, a second transmission gear and a third transmission gear;
the first rotary teeth-uncompleted gear is provided at one end of the rotary shaft, and the second rotary teeth-uncompleted gear is provided at another end of the rotary shaft; and
the first transmission gear is fixedly provided at a fixed shaft of the test cylinder, the second transmission gear and the third transmission gear are coaxially provided at the vibration platform, the first transmission gear is engaged with the second transmission gear, and the third transmission gear is suitable for being engaged with the second rotary teeth-uncompleted gear.

According to the test device for performance of the seal under multi-stage vibration provided by the present application, the first vibration assembly includes a first vibration bevel gear, a cam and a push rod; and
the first vibration bevel gear is provided at a preset mount position, the first vibration bevel gear is suitable for being engaged with the first rotary teeth-uncompleted gear, the cam and the first vibration bevel gear are coaxially provided, the push rod is provided in a guiding manner at the vibration platform, the push rod is located at a rotation path of the cam, and the push rod is suitable for performing linear reciprocal motion with the cam to make the test cylinder move in a vertical direction.

According to the test device for performance of the seal under multi-stage vibration provided by the present application, the first vibration assembly further includes an axle sleeve, the axle sleeve sleeves the fixed shaft and abuts against a bottom wall of the test cylinder; the axle sleeve is provided with a limit flange, and the push rod is suitable for abutting against the limit flange to drive the test cylinder to move upward in a vertical direction through the axle sleeve.

According to the test device for performance of the seal under multi-stage vibration provided by the present application, the second vibration assembly includes a second vibration bevel gear, a horizontal swing module and a transmission component; and
the second vibration bevel gear is provided at a preset mount position, the second vibration bevel gear is suitable for being engaged with the first rotary teeth-uncompleted gear, the horizontal swing module penetrates through the vibration platform and is clamped to an outer circumferential surface of the test cylinder, and the transmission component is connected to a transmission shaft of the second vibration bevel gear and the horizontal swing module, respectively.

According to the test device for performance of the seal under multi-stage vibration provided by the present application, the horizontal swing module includes a horizontal swing teeth-uncompleted gear, a swing member and a guide; and
the horizontal swing teeth-uncompleted gear is connected to the transmission component;
the swing member is provided with a snap slot matched with the outer circumferential surface of the test cylinder, the snap slot abuts against the outer circumferential surface of the test cylinder, and a main body of the swing member abuts against a wall of a groove in a side wall of the vibration platform; the swing member is provided with a swing gear ring, and the swing gear ring is suitable for being engaged with the horizontal swing teeth-uncompleted gear; and
the guide is embedded in the vibration platform, and the guide is provided with a guide slot use for enabling the swing member to move horizontally.

According to the test device for performance of the seal under multi-stage vibration provided by the present application, the multi-stage vibration mechanism further includes a third vibration assembly, the third vibration assembly is connected to at least one side of the vibration platform, and is used to drive the vibration platform to swing along a support shaft of the vibration platform to drive the test cylinder to swing.

According to the test device for performance of the seal under multi-stage vibration provided by the present application, the third vibration assembly includes an extension shaft, a third vibration teeth-uncompleted gear, a vibration gear ring and a link, where the vibration gear ring is provided with a connector, one end of the link is hinged to the connector, and another end of the link is hinged to an outer wall of the vibration platform;
the extension shaft is connected to the rotary shaft, and both the extension shaft and the rotary shaft are suitable for moving in a vertical direction to be switchable between a first position and a second position;
in the first position, the third vibration teeth-uncompleted gear is completely disengaged from the vibration gear ring, the second rotary teeth-uncompleted gear is suitable for being engaged with the third transmission gear, and the first rotary teeth-uncompleted gear is suitable for being engaged with the first vibration bevel gear or the second vibration bevel gear; and
in the second position, the second rotary teeth-uncompleted gear is completely disengaged from the third transmission gear, the first rotary teeth-uncompleted gear is completely disengaged from the first vibration bevel gear and the second vibration bevel gear; and the third vibration teeth-uncompleted gear is engaged with the vibration gear ring.

According to the test device for performance of the seal under multi-stage vibration provided by the present application, the vibration platform includes a first vibration body, a second vibration body and two support bodies;
a first vibration cavity is provided inside the first vibration body, a shape of the first vibration cavity is matched with the shape of the test cylinder, and the test cylinder is provided in the first vibration cavity;
a limit cavity is provided inside the second vibration body, a shape of the limit cavity is matched with a shape of the first vibration body, and the first vibration body is provided in the limit cavity; and both sides of the first vibration body are limited and both sides of the first vibration body are suitable for reciprocally swing in the horizontal direction in the limit cavity; and
the two support bodies are symmetrically provided at opposite sides of the second vibration body, each support body is suitable for being fixed to a preset mount position, and the second vibration body is matched with each support body in a guiding manner, and is suitable for swinging along a support shaft of the support body.

In the test device for sealing material under complex vibration provided by the present application, by providing the vibration component comprising the vibration platform and the multi-stage vibration mechanism as well as the test assembly, the test device may be used to simulate use states of a seal under complex working conditions to verify the reliability and stability of the seal under complex vibration conditions. The entire vibration assembly is composed of a mechanical structure with high structural strength, which may make the vibration parameters (frequency, amplitude, phase) highly adjustable, various vibration modes from low frequency to high frequency are accurately simulated to meet different test requirements. The test device may bear large weight samples and is suitable for vibration test of heavy equipment and large structural parts.

### BRIEF DESCRIPTION OF THE DRAWINGS

To illustrate solutions of the present application or in the related art more clearly, accompanying drawings that needs to be used in the description of the embodiments or the related art are briefly described below. The drawings described below are only some embodiments of the present application. For those skilled in the art, other drawings may also be obtained based on these drawings without creative effort.

FIG. 1 is a first schematic structural diagram of a test device for sealing material under complex vibration according to an embodiment of the present application.

FIG. 2 is a second schematic structural diagram of a test device for sealing material under complex vibration according to an embodiment of the present application.

FIG. 3 is a side view of a seal under a multi-stage vibration working condition according to an embodiment of the present application.

FIG. 4 is a cross-sectional view along A-A line shown in FIG. 3.

FIG. 5 is a schematic exploded view of a layout structure of a test device for sealing material under complex vibration according to an embodiment of the present application.

FIG. 6 is a schematic structural diagram of a test device for sealing material under complex vibration according to an embodiment of the present application.

FIG. 7 is a first front view of a test device for sealing material under complex vibration (in a first position) according to an embodiment of the present application.

FIG. 8 is a second front view of a test device for sealing material under complex vibration (in a second position) according to an embodiment of the present application.

### REFERENCE NUMERALS

10: test body; 11: test cylinder; 111: fixed shaft; 12: cover body;
20: vibration platform; 21: first vibration body; 211: first vibration cavity; 22: second vibration body; 221: limit cavity; 23: support body;
30: multi-stage vibration mechanism; 31: rotation assembly; 311: rotary shaft; 312: first rotary teeth-uncompleted gear; 313: second rotary teeth-uncompleted gear; 314: first transmission gear; 315: second transmission gear; 316: third transmission gear; 32: first vibration assembly; 321: first vibration bevel gear; 322: cam; 323: push rod; 324: axle sleeve; 33: second vibration assembly; 331: second vibration bevel gear; 332: horizontal swing module; 3321: horizontal swing teeth-uncompleted gear; 3322: swing member; 3322-1: snap slot; 3322-2: swing gear ring; 3323: guide; 3323-1: guide slot; 333: transmission component; 3331: first pulley; 3332: second pulley; 3333: transmission belt; 34: third vibration assembly; 341: extension shaft; 342: third vibration teeth-uncompleted gear; 343: vibration gear ring; 344: link.

### DETAILED DESCRIPTION

To illustrate objectives, solutions and advantages of the present application more clearly, the solutions in the present application will be described below clearly and completely in conjunction with the accompanying drawings in the present application. The described embodiments are part of the embodiments of the present application, rather than all of the embodiments. All other embodiments obtained by those skilled in the art based on the embodiments of the present application without any creative work belong to the scope of the present application.

In the description of embodiments of the present application, it should be noted that, unless otherwise explicitly specified and defined, the terms “connected to” and “connected” shall be understood broadly. For example, it may be either fixedly connected or detachably connected, or may be integratedly connected; it may be either mechanically connected, or electrically connected; it may be either directly connected, or indirectly connected through an intermediate medium. The specific meanings of the terms above in embodiments of the present application may be understood by those skilled in the art in accordance with specific conditions.

In the embodiments of the present application, unless otherwise clearly stated and defined, the first feature being located “on” or “under” the second feature means that the first feature is in direct contact with the second feature or the first feature is in indirect contact with the second feature by an intervening media. In addition, the first feature is “on”, “above” and “over” the second feature can refer to that the first feature is directly above or obliquely above the second feature, or simply refer to that the level height of the first feature is higher than that of the second feature. The first feature is “under”, “below” and “beneath” the second feature can refer to that the first feature is directly below or obliquely below the second feature, or simply refer to that the level height of the first feature is lower than that of the second feature.

In the description of this specification, description with reference to the terms “one embodiment”, “some embodiments”, “an example”, “specific example”, “some examples” and the like, refers to that specific features, structures, materials or characteristics described in combination with an embodiment or an example are included in at least one embodiment or example according to the embodiments of the present application. In this specification, schematic representations of the above terms are not necessarily directed to a same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

Hydrogen gas may penetrate many traditional sealing materials since hydrogen gas is extremely light and molecules of hydrogen gas are very small. Hence, for special seals used in hydrogen gas application scenarios (such as the energy, chemical, and aerospace industries), it is necessary to consider their special permeability and safety requirements, and it is crucial to test performance of seals especially in hydrogen fuel cells, hydrogen storage and transportation systems.

In the above-mentioned application fields, seals need to withstand complex and changeable working conditions, such as high pressure, low temperature, long-term operation, etc., which are usually accompanied by mechanical vibrations. For example, various vibration sources exist in hydrogen compressors, hydrogen storage tanks, hydrogen delivery pipelines and fuel cell systems. Vibration may cause displacement, loosening or even failure of seals. In this way, hydrogen gas with extremely small molecules is prone to leakage during vibration, which may lead to safety accidents such as explosions or fires in severe cases. An embodiment of the present application provides a test device for sealing material under complex vibration.

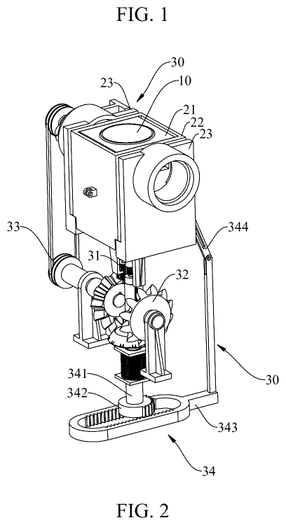

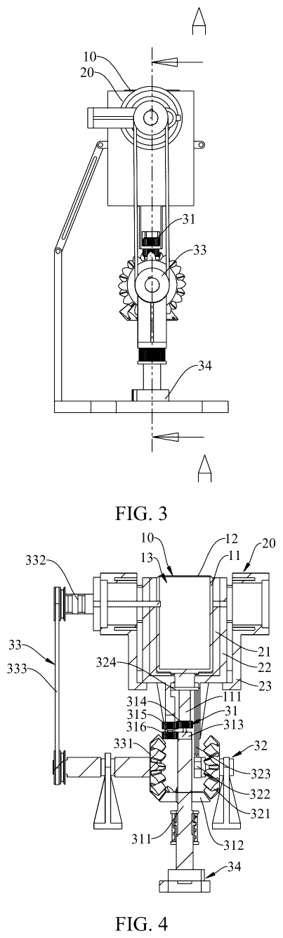

FIG. 1 is a first schematic structural diagram of a test device for sealing material under complex vibration according to an embodiment of the present application. FIG. 2 is a second schematic structural diagram of a test device for sealing material under complex vibration according to an embodiment of the present application. FIG. 3 is a side view of a seal under a multi-stage vibration working condition according to an embodiment of the present application. FIG. 4 is a cross-sectional view along A-A line in FIG. 3.

Referring to FIG. 1 to FIG. 4, an embodiment of the present application provides a test device for sealing material under complex vibration, which is used to simulate use states of a seal under complex working conditions to verify the reliability and stability of the seal under complex vibration conditions. The test device for sealing material under complex vibration, includes a test body 10, a vibration component and a test assembly.

The test body 10 includes a test cylinder 11 and a cover body 12, a test cavity is provided inside the test cylinder 11 and used to store a seal medium. The cover body 12 covers the test cylinder 11 to close the test cavity. A seal to be tested is provided between the cover body 12 and the test cylinder 11. That is, the seal to be tested is mounted on the test body 10 in a normal use manner. The test body 10 may simulate interface relationships with surrounding components in actual work.

The test body 10 may be adaptively adjusted according to application scenarios of the seal and the test body 10 has different structures in different application scenarios. During the test, parameters such as a vibration frequency, an amplitude, a direction, a temperature, a pressure, etc. are pre-set according to different application scenarios to ensure that the test environment may reproduce the expected working conditions.

The vibration component includes a vibration platform 20 and a multi-stage vibration mechanism 30. The vibration platform 20 is suitable for being fixed to a preset mount position and the vibration platform 20 needs to have good rigidity and flatness to accurately transmit vibration energy. The vibration platform 20 may be fixed on the ground or on the test bench by fasteners such as bolts to ensure that the vibration platform 20 remains stable. The preset mount position may be set to the ground or a table of the test bench according to a test scenario. The test cylinder 11 is embedded in the vibration platform 20, the multi-stage vibration mechanism 30 is connected to the vibration platform 20, and is suitable for simulating multi-stage vibration conditions by driving the test cylinder 11 through the vibration platform 20.

The test assembly includes sensors and a control component (not shown in the figure), the sensors are electrically connected to the control component, and the sensors are used to monitor sealing performance of the test cavity and feed back corresponding monitored information to the control component.

Types of sensors may include pressure sensors, displacement sensors, vibration sensors, stress/strain sensors, and optical sensors. The pressure sensors are used to monitor static and dynamic pressures at both sides of the seal, check whether there is leakage, and confirm the seal effect. The displacement sensors are used to monitor displacement change of the seal under force or vibration, and detect its recovery capability and deformation. The vibration sensors such as accelerometers capture information such as vibration frequency and amplitude to help analyze behavioral characteristics of the seal under multi-stage vibration. The stress/strain sensors are used to quantify stress distribution inside or on the surface of the seal and understand the pressure bearing capacity and fatigue state of the seal. The optical sensors are used to observe whether there are cracks, damage, etc. on the appearance of the seal through visual or infrared imaging. The sensors are selected according to the adaptability of the actual use scenario. No matter which sensor is selected, each sensor is electrically connected to the control component to feed back the monitored information to the control component in real time, and the monitored information is recorded and analyzed by the control component.

The control component is mainly used to receive information, process information and issue instructions. The control component may be a programmable logic controller (PLC), a microprocessor or a microcontroller unit (MCU) and a central processing unit (CPU), etc.

It may be understood that in the test device for sealing material under complex vibration provided by an embodiment of the present application, by providing the vibration component comprising the vibration platform 20 and the multi-stage vibration mechanism 30 as well as the test assembly, the test device may be used to simulate use states of a seal under complex working conditions to verify the reliability and stability of the seal under complex vibration conditions. The entire vibration assembly is composed of a mechanical structure with high structural strength, which may make the vibration parameters (frequency, amplitude, phase) highly adjustable, various vibration modes from low frequency to high frequency are accurately simulated to meet different test requirements. The test device may bear large weight samples and is suitable for vibration test of heavy equipment and large structural parts.

Continuously referring to FIG. 1 to FIG. 4, in some embodiments of the present application, the multi-stage vibration mechanism 30 includes a drive assembly, a rotation assembly 31, a first vibration assembly 32 and a second vibration assembly 33.

The rotation assembly 31 is connected to the test cylinder 11 to drive the test cylinder 11 to rotate, the first vibration assembly 32 is suitable for abutting against the test cylinder 11 to drive the test cylinder 11 to vibrate in a vertical direction, the second vibration assembly 33 is suitable for abutting against the test cylinder 11 to drive the test cylinder 11 to swing in a horizontal direction, the drive assembly is connected to any one of the rotation assembly 31, the first vibration assembly 32 and the second vibration assembly 33, and is used to drive the rotation assembly 31, the first vibration assembly 32 and the second vibration assembly 33 to perform staged vibration.

That is, the embodiment of the present application uses a drive assembly (such as a motor) to control multiple groups of vibration units, that is, uses a motor to control the rotation assembly 31, the first vibration assembly 32 and the second vibration assembly 33 to perform staged vibration. This arrangement may not only reduce the number of motors, but also make the structure of the test device for sealing material under complex vibration more compact and reduce an occupation area. Moreover, multiple vibration assemblies use a unified power source to facilitate the precise synchronization between multiple transmission components and improve the overall coordination and smoothness. Simultaneously, unified control may optimize vibration modes, reduce noise pollution and mechanical wear, avoid resonance effects caused by the independent operation of multiple motors, and further improve the test accuracy.

Continuously referring to FIG. 4, in some embodiments of the present application, the rotation assembly 31 includes a rotary shaft 311, a first rotary teeth-uncompleted gear 312, a second rotary teeth-uncompleted gear 313, a first transmission gear 314, a second transmission gear 315 and a third transmission gear 316. The first rotary teeth-uncompleted gear 312 is provided at one end of the rotary shaft 311, and the second rotary teeth-uncompleted gear 313 is provided at another end of the rotary shaft 311. The first transmission gear 314 is fixedly provided at a fixed shaft 111 of the test cylinder, and is used to transmit power to the test cylinder 11 for driving the test cylinder 11 to rotate. The second transmission gear 315 and the third transmission gear 316 are coaxially provided at the vibration platform 20, the first transmission gear 314 is engaged with the second transmission gear 315, and the third transmission gear 316 is suitable for being engaged with the second rotary teeth-uncompleted gear 313.

The rotary shaft 311 is used as a main body for bearing and transmitting torque, and the first rotary teeth-uncompleted gear 312 and the second rotary teeth-uncompleted gear 313 are provided at both ends of the rotary shaft 311, respectively. The first rotary teeth-uncompleted gear 312 may achieve timing intermittent contact with other gears or teeth-uncompleted gears through the teeth-uncompleted design. The second rotary teeth-uncompleted gear 313 is also teeth-uncompleted and may form a similar timing contact with the third transmission gear 316.

The rotary shaft 311 drives the first rotary teeth-uncompleted gear 312 and the second rotary teeth-uncompleted gear 313 to rotate synchronously when the power source (motor) drives the rotary shaft 311 to rotate. As the rotary shaft 311 continues to rotate, a gap on the second rotary teeth-uncompleted gear 313 periodically contacts the third transmission gear 316 to achieve intermittent output of power. The second transmission gear 315 is between the first transmission gear 314 and the third transmission gear 316, and plays a role in power transfer to transfer the power of the third transmission gear 316 to the first transmission gear 314, and the first transmission gear 314 transmits the power to the test cylinder 11 to drive the test cylinder 11 to rotate, achieving the rotational movement of the test cylinder 11.

The timing start and pause of power transmission may be achieved, and the vibration frequency and duration may be precisely controlled by precisely designing the shapes of the first rotary teeth-uncompleted gear 312 and the second rotary teeth-uncompleted gear 313. The intermittent meshing between the teeth-uncompleted gears enables the vibration platform 20 to flexibly change vibration modes according to actual needs and adapt to different experimental requirements or working conditions.

Continuously referring to FIG. 4, in some embodiments of the present application, the first vibration assembly 32 includes a first vibration bevel gear 321, a cam 322 and a push rod 323. The first vibration bevel gear 321 is provided at a preset mount position, the first vibration bevel gear 321 is suitable for being engaged with the first rotary teeth-uncompleted gear 312, the cam 322 and the first vibration bevel gear 321 are coaxially provided, the push rod 323 is provided in a guiding manner at the vibration platform 20, the push rod 323 is located at a rotation path of the cam 322, and the push rod 323 is suitable for performing linear reciprocal motion with the cam 322 to make the test cylinder 11 move in a vertical direction.

The first vibration bevel gear 321 may be mounted at a preset mount position (such as the ground or the tabletop of a laboratory table) through a transmission shaft provided at a bearing seat. The first vibration bevel gear 321 is a component of the first vibration assembly 32 that directly receives the rotary power. The first vibration bevel gear 321 is engaged with the first rotary teeth-uncompleted gear 312 to achieve intermittent input of power. The cam 322 and the first vibration bevel gear 321 are coaxially provided, and the push rod 323 produces linear reciprocating motion using interaction between a profile surface of the cam 322 and the push rod 323. The push rod 323 may directly abut against a bottom surface of the test cylinder 11, or may indirectly lift the test cylinder 11 through an intermediate structure, and the test cylinder 11 vibrates in the vertical direction with the movement of the push rod 323.

When the first vibration bevel gear 321 is engaged with the first rotary teeth-uncompleted gear 312, the rotary power of the first rotary teeth-uncompleted gear 312 is transmitted to the first vibration assembly 32, and the rotation of the first vibration bevel gear 321 drives the coaxially provided cam 322 to rotate together, and the contact point of the profile of the cam 322 and the push rod 323 constantly changes. As the profile surface of the cam 322 changes, the push rod 323 is subjected to an outward force and performs a linear reciprocal motion along the pre-designed guide slot 3323-1. The linear motion of the push rod 323 is directly or indirectly converted into the vibration of the test cylinder 11 in the vertical direction.

The shape of the cam 322 in the embodiment of the present application determines a stroke and a speed of the push rod 323 and accurate vibration frequency and amplitude adjustment may be achieved by optimizing the shape design of the cam 322. That is, vibration modes may be changed to meet different experimental requirements by adjusting the size and shape of the cam 322.

In some embodiments of the present application, the first vibration assembly 32 further includes an axle sleeve 324. The axle sleeve 324 sleeves the fixed shaft 111 and abuts against a bottom wall of the test cylinder 11; the axle sleeve 324 is provided with a limit flange, and the push rod 323 is suitable for abutting against the limit flange to drive the test cylinder 11 to move upward in a vertical direction through the axle sleeve 324.

In the embodiment of the present application, the push rod 323 indirectly contacts the bottom wall of the test cylinder 11 through the axle sleeve 324, and the linear motion of the push rod 323 is indirectly converted into the vibration of the test cylinder 11 upwardly in the vertical direction through the axle sleeve 324. The axle sleeve 324 and the test cylinder 11 fall freely under the action of gravity when the push rod 323 cancels the force applied to the axle sleeve 324.

Continuously referring to FIG. 4, in some embodiments of the present application, the second vibration assembly 33 includes a second vibration bevel gear 331, a horizontal swing module 332 and a transmission component 333. The second vibration bevel gear 331 is provided at a preset mount position, the second vibration bevel gear 331 is suitable for being engaged with the first rotary teeth-uncompleted gear 312, the horizontal swing module 332 penetrates through a rotary center of a support shaft of the vibration platform 20 and is clamped to an outer circumferential surface of the test cylinder 11, and the transmission component 333 is connected to a transmission shaft of the second vibration bevel gear 331 and the horizontal swing module 332, respectively.

The second vibration bevel gear 331 may be mounted at a preset mount position (such as the ground or the tabletop of a laboratory table) through a transmission shaft provided at a bearing seat. The second vibration bevel gear 331 is a component of the second vibration assembly 33 that receives the power. The second vibration bevel gear 331 is engaged with the first rotary teeth-uncompleted gear 312 to achieve intermittent input of power. The horizontal swing module 332 directly acts on the outer circumferential surface of the test cylinder 11 to achieve lateral vibration of the test cylinder 11 and enhance the multi-dimensional simulation of experimental conditions. The transmission component 333 is connected to the second vibration bevel gear 331 and the horizontal swing module 332 at a certain distance to convert the rotary kinetic energy of the second vibration bevel gear 331 into lateral swing potential energy, which ensures efficient transmission of vibration.

The second vibration bevel gear 331 receives power from the first rotary teeth-uncompleted gear 312 and starts to rotate when being engaged with the first rotary teeth-uncompleted gear 312. The transmission component 333 (such as a chain component, a belt component or a coupling, etc.) converts the rotary motion of the second vibration bevel gear 331 into the lateral vibration of the horizontal swing module 332. The horizontal swing module 332 applies kinetic energy to the test cylinder 11 in a lateral form, causing the test cylinder 11 to vibrate in the X-Y plane. This vibration is combined with the vertical vibration to form a composite vibration field in a three-dimensional space for simulating complex mechanical environment experienced by the test cylinder 11 in actual working conditions.

It should be noted that the transmission component 333 may be a belt component. That is, the transmission component 333 includes a first pulley 3331, a second pulley 3332 and a transmission belt 3333. The first pulley 3331 and the second vibration bevel gear 331 are coaxially provided, the second pulley 3332 is mounted at a preset mount position through a transmission shaft provided at the bearing seat, and the transmission belt 3333 is matched with the first pulley 3331 and the second pulley 3332 in a transmission manner.

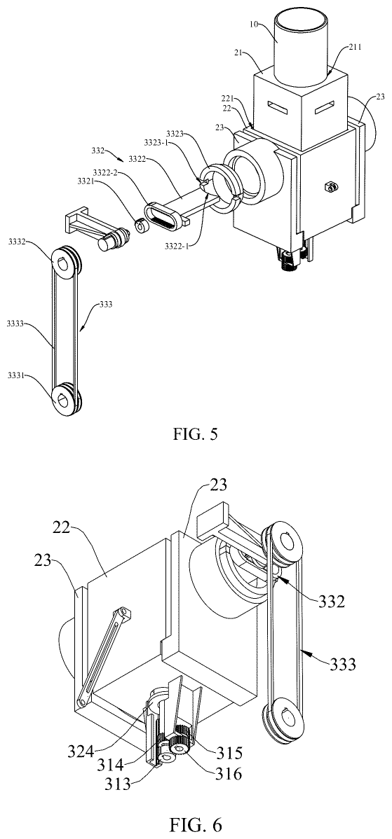

FIG. 5 is a schematic exploded view of a layout structure of a test device for sealing material under complex vibration according to an embodiment of the present application. FIG. 6 is a schematic structural diagram of a test device for sealing material under complex vibration according to an embodiment of the present application.

Referring to FIG. 5 and FIG. 6, in some embodiments of the present application, the horizontal swing module 332 includes a horizontal swing teeth-uncompleted gear 3321, a swing member 3322 and a guide 3323. The horizontal swing teeth-uncompleted gear 3321 is connected to the transmission component 333. The swing member 3322 is provided at the rotary center of the support shaft of the vibration platform 20. The swing member 3322 may avoid interfering with the movement of the second vibration body 22 when the second vibration body 22 of the vibration platform 20 swings around the support shaft.

The swing member 3322 is provided with a snap slot 3322-1 matched with the outer circumferential surface of the test cylinder 11. The snap slot 3322-1 abuts against the outer circumferential surface of the test cylinder 11, and a main body of the swing member 3322 abuts against a wall of a groove in a side wall of the vibration platform 20. The swing member 3322 is provided with a swing gear ring 3322-2, and the swing gear ring 3322-2 is suitable for being engaged with the horizontal swing teeth-uncompleted gear 3321. The guide 3323 is embedded in one of the support bodies 23, and the guide is provided with a guide slot used for enabling the swing member to move horizontally.

The horizontal swing module 332 is used as a core part of the second vibration assembly 33, and the horizontal swing teeth-uncompleted gear 3321 is coaxially provided with the second pulley 3332 and used as a power receiving end of the horizontal swing module 332. The horizontal swing teeth-uncompleted gear 3321 may coordinate with the vibration assembly through a specific teeth-uncompleted design to ensure accurate energy transmission. The swing member 3322 is provided with the snap slot 3322-1 matched with an outer diameter of the test cylinder 11, which may be in close fit with the test cylinder 11 to ensure that the vibration is directly and evenly transmitted to the test cylinder 11 to reduce energy loss and improve vibration efficiency. The guide 3323 is firmly embedded in a fixed sleeve of each support body 23 to play a guiding role. A motion trajectory of the swing member 3322 is limited by providing a guide slot 3323-1 on the guide 3323 to ensure that the swing member 3322 only swings in the expected horizontal direction. Simultaneously, the design of the guide 3323 may rotate around the support shaft to serve the above role.

It should be noted that no guide 3323 may be provided, and the guide slot 3323-1 may be directly provided at the fixed sleeve of each support body 23 to limit the motion trajectory of the swing member 3322.

When the horizontal swing teeth-uncompleted gear 3321 receives a rotary power from the second pulley 3332 of the transmission component 333 and starts to rotate, the horizontal swing teeth-uncompleted gear 3321 is engaged with a gear ring of the swing member 3322, converts the rotary motion into the lateral vibration of the swing member 3322. The swing member 3322 performs a controlled horizontal swing along the guide slot 3323-1 under the constraint of the guide 3323 to ensure that the vibration is stable and orderly. In this case, the snap slot 3322-1 at the end of the swing member 3322 tightly clamps the test cylinder 11, transfers the lateral vibration energy to the test cylinder 11, and makes the test cylinder 11 realize lateral vibration.

In the embodiment of the present application, a swing angle and frequency may be controlled by accurately providing the gear ratio and the guide path to achieve a highly accurate vibration effect. In addition, the test cylinder 11 may be continuously switchable between vertical swing, horizontal swing and rotary vibration by adjusting the corresponding teeth-uncompleted position of the teeth-uncompleted gear.

Continuously referring to FIG. 1 to FIG. 6, in some embodiments of the present application, the multi-stage vibration mechanism 30 further includes a third vibration assembly 34, the third vibration assembly 34 is connected to at least one side of the vibration platform 20, and is used to drive the vibration platform 20 to swing along a support shaft of the vibration platform for driving the test cylinder 11 to swing.

Equivalently, the embodiment of the present application provides an additional swinging motion. The test cylinder 11 may not only perform rotary vibration, upward and downward vibration, and horizontal vibration, but also perform leftward and rightward swing around a rotary center of the vibration platform 20, to form a richer three-dimensional vibration mode, simulate a complex real environment in combination with the above-mentioned vibration. The test cylinder 11 vibrates in the three axes of XYZ to be close to the complex vibration state of nature.

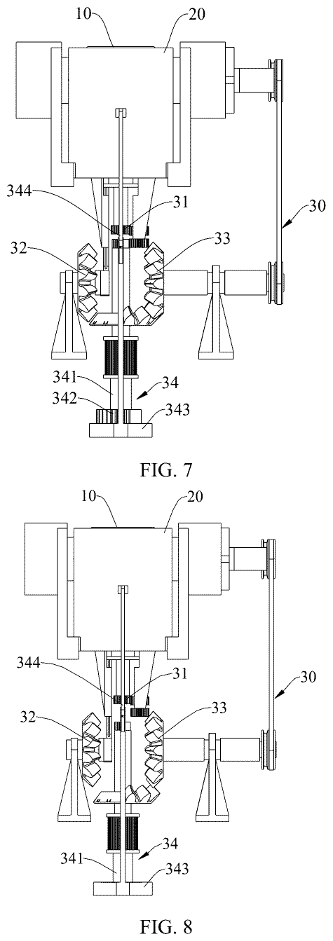

FIG. 7 is a first front view of a test device for sealing material under complex vibration (in a first position) according to an embodiment of the present application. FIG. 8 is a second front view of a test device for sealing material under complex vibration (in a second position) according to an embodiment of the present application.

Continuously referring to FIG. 1 to FIG. 4, and further to FIG. 7 and FIG. 8, in some embodiments of the present application, the third vibration assembly 34 includes an extension shaft 341, a third vibration teeth-uncompleted gear 342, a vibration gear ring 343 and a link 344, where the vibration gear ring 343 is provided with a connector, one end of the link 343 is hinged to the connector, and another end of the link 344 is hinged to an outer wall of the vibration platform 20.

The extension shaft 341 is connected to the rotary shaft 311, and both the extension shaft 341 and the rotary shaft 311 are suitable for moving in a vertical direction to be switchable between a first position and a second position.

It should be noted that the extension shaft 341 and the rotary shaft 311 may be one shaft, which is equivalent to dividing one shaft into two parts for the convenience of distinguishing from the above embodiments. The extension shaft 341 and the rotary shaft 311 may also be two independent parts, which are connected to each other through a coupling or the like. Regardless of the setting, the extension shaft 341 and the rotary shaft 311 always keep synchronous movement in the vertical direction.

At least one of the extension shaft 341 and the rotary shaft 311 may be mounted on a linear drive module (not shown in the figure) through a bearing seat. The linear drive module may be a linear guide and a ball screw or a linear motor, and the linear drive module is fixed at a suitable position on the test table. That is, the extension shaft 341 and the rotary shaft 311 achieve position switching through the linear drive module.

As shown in FIG. 7, in the first position, the third vibration teeth-uncompleted gear 342 is completely disengaged from the vibration gear ring 343. That is, the vibration gear ring 343 does not participate in the motion, and the third vibration assembly 34 does not engage into the vibration system. At this time, the second rotary teeth-uncompleted gear 313 is suitable for being engaged with the third transmission gear 316 to maintain conventional rotary vibration, and the first rotary teeth-uncompleted gear 312 is suitable for being engaged with the first vibration bevel gear 321 or the second vibration bevel gear 331 to achieve the vibration of the test cylinder 11 in the vertical and horizontal directions.

As shown in FIG. 8, in the second position, the second rotary teeth-uncompleted gear 313 is completely disengaged from the third transmission gear 316, that is, the conventional rotary vibration is interrupted. The first rotary teeth-uncompleted gear 312 is completely disengaged from the first vibration bevel gear 321 and the second vibration bevel gear 331, that is, an original vibration mode is stopped. At this time, the third vibration teeth-uncompleted gear 342 is engaged with the vibration gear ring 343 and the vibration gear ring 343 moves to excite the swing of the vibration platform 20 through the link 344 to drive the test cylinder 11 to swing, and introduce a swing mode of the third vibration assembly 34.

In an embodiment of the present application, the swing mode of the third vibration assembly 34 may be inserted into the vibration mode described above at any time by controlling a moving path of the linear drive module, thereby realizing any combination of multiple vibration modes.

Continuously referring to FIG. 1 to FIG. 8, in some embodiments of the present application, the vibration platform 20 includes a first vibration body 21, a second vibration body 22 and two support bodies 23.

A first vibration cavity 211 is provided inside the first vibration body 21, a shape of the first vibration cavity 211 is matched with the shape of the test cylinder 11, and the test cylinder 11 is provided in the first vibration cavity 211 to ensure that a vibration force is evenly transmitted to the test cylinder 11. A limit cavity 221 is provided inside the second vibration body 22, a shape of the limit cavity 221 is matched with a shape of the first vibration body 21, and the first vibration body 21 is provided in the limit cavity 221; and both sides of the first vibration body 21 are limited and suitable for reciprocally swing in the horizontal direction in the limit cavity 221, that is, the first vibration body 21 is allowed to vibrate in the horizontal direction in the limit cavity 221.

The two support bodies 23 are symmetrically provided at opposite sides of the second vibration body 22, each support body 23 is suitable for being fixed to a preset mount position (the ground or the tabletop of a laboratory table) to form a stable base. The second vibration body 22 is matched with each support body 23 in a guiding manner, and is suitable for swinging along a support shaft of the support body 23, that is, the support body 23 is allowed to swing around the support shaft, thereby realizing multi-dimensional vibration.

Equivalently, the first vibration body 21 directly fits with the test cylinder 11 through the built-in first vibration cavity 211, and transmits the vibration to the test cylinder 11 without loss. The second vibration body 22, as an external frame, surrounds the first vibration body 21 through the limit cavity 221 to ensure its stable position and allow the necessary vibration freedom. With the help of two support bodies 23, the second vibration body 22 may then swing around the axis within a specific range, a lateral vibration mode is added to enrich the vibration mode.

That is, when the vibration platform 20 vibrates, the first vibration body 21 will swing around the support shaft with the second vibration body 22 since the first vibration body 21 is assembled in the second vibration body 22, while the snap slot 3322-1 provided at the end of the swinging member 3322 abuts against the outer circumferential surface of the test cylinder 11, and the swinging member 3322 will also swing with the second vibration body 22. The swinging member 3322 will not interfere with the swinging of the second vibration body 22 around the support shaft when the second vibration body 22 swings around the support shaft since the swinging member 3322 is located at the rotary center of the support shaft.

In the embodiment of the present application, test cylinders 11 of different sizes and weights may be adapted by adjusting the angle and length of each support body 23.

Finally, it should be noted that the above embodiments are only used to explain the solutions of the present application, and are not limited thereto; although the present application is described in detail with reference to the foregoing embodiments, it should be understood by those skilled in the art that they can still modify the solutions described in the foregoing embodiments and make equivalent replacements to a part of the features and these modifications and substitutions do not depart from the scope of the solutions of the embodiments of the present application.

What is claimed is:

1. A test device for sealing material under complex vibration, the test device comprising:
a test body, comprising a test cylinder and a cover body, wherein a test cavity is provided inside the test cylinder, the cover body covers the test cylinder to close the test cavity, and a seal to be tested is provided between the cover body and the test cylinder;
a vibration component, comprising a vibration platform and a multi-stage vibration mechanism, wherein the vibration platform is suitable for being fixed to a preset mount position, the test cylinder is embedded in the vibration platform, and the multi-stage vibration mechanism is connected to the vibration platform, and is suitable for simulating multi-stage vibration conditions by driving the test cylinder through the vibration platform; and
a test assembly, comprising sensors and a control component, wherein the sensors are electrically connected to the control component, and the sensors are used to monitor sealing performance of the test cavity and feed back corresponding monitored information to the control component.

2. The test device of claim 1, wherein the multi-stage vibration mechanism comprises a drive assembly, a rotation assembly, a first vibration assembly and a second vibration assembly;
wherein the rotation assembly is connected to the test cylinder to drive the test cylinder to rotate, the first vibration assembly is suitable for abutting against the test cylinder to drive the test cylinder to vibrate in a vertical direction, the second vibration assembly is suitable for abutting against the test cylinder to drive the test cylinder to swing in a horizontal direction, and
the drive assembly is connected to any one of the rotation assembly, the first vibration assembly and the second vibration assembly, and is used to drive the rotation assembly, the first vibration assembly and the second vibration assembly to perform staged vibration.

3. The test device for sealing material under complex vibration of claim 2, wherein the rotation assembly comprises a rotary shaft, a first rotary teeth-uncompleted gear, a second rotary teeth-uncompleted gear, a first transmission gear, a second transmission gear and a third transmission gear;
wherein the first rotary teeth-uncompleted gear is provided at one end of the rotary shaft, and the second rotary teeth-uncompleted gear is provided at another end of the rotary shaft; and
the first transmission gear is fixedly provided at a fixed shaft of the test cylinder, the second transmission gear and the third transmission gear are coaxially provided at the vibration platform, the first transmission gear is engaged with the second transmission gear, and the third transmission gear is suitable for being engaged with the second rotary teeth-uncompleted gear.

4. The test device of claim 3, wherein the first vibration assembly comprises a first vibration bevel gear, a cam and a push rod;
wherein the first vibration bevel gear is provided at a preset mount position, the first vibration bevel gear is suitable for being engaged with the first rotary teeth-uncompleted gear, the cam and the first vibration bevel gear are coaxially provided, the push rod is provided in a guiding manner at the vibration platform, the push rod is located at a rotation path of the cam, and the push rod is suitable for performing linear reciprocal motion with the cam to make the test cylinder move in a vertical direction.

5. The test device of claim 4, wherein the first vibration assembly further comprises an axle sleeve, the axle sleeve sleeves the fixed shaft and abuts against a bottom wall of the test cylinder; the axle sleeve is provided with a limit flange, and the push rod is suitable for abutting against the limit flange to drive the test cylinder to move upward in a vertical direction through the axle sleeve.

6. The test device of claim 3, wherein the second vibration assembly comprises a second vibration bevel gear, a horizontal swing module and a transmission component; and
the second vibration bevel gear is provided at a preset mount position, the second vibration bevel gear is suitable for being engaged with the first rotary teeth-uncompleted gear, the horizontal swing module penetrates through the vibration platform and is clamped to an outer circumferential surface of the test cylinder, and the transmission component is connected to a transmission shaft of the second vibration bevel gear and the horizontal swing module, respectively.

7. The test device of claim 6, wherein the horizontal swing module comprises a horizontal swing teeth-uncompleted gear, a swing member and a guide; and
the horizontal swing teeth-uncompleted gear is connected to the transmission component;
the swing member is provided with a snap slot matched with the outer circumferential surface of the test cylinder, the snap slot abuts against the outer circumferential surface of the test cylinder, and a main body of the swing member abuts against a wall of a groove in a side wall of the vibration platform; the swing member is provided with a swing gear ring, and the swing gear ring is suitable for being engaged with the horizontal swing teeth-uncompleted gear; and
the guide is embedded in the vibration platform, and the guide is provided with a guide slot used for enabling the swing member to move horizontally.

8. The test device of claim 3, wherein the multi-stage vibration mechanism further comprises a third vibration assembly, the third vibration assembly is connected to at least one side of the vibration platform, and is used to drive the vibration platform to swing along a support shaft of the vibration platform to drive the test cylinder to swing.

9. The test device of claim 4, wherein the multi-stage vibration mechanism further comprises a third vibration assembly, the third vibration assembly is connected to at least one side of the vibration platform, and is used to drive the vibration platform to swing along a support shaft of the vibration platform to drive the test cylinder to swing.

10. The test device of claim 5, wherein the multi-stage vibration mechanism further comprises a third vibration assembly, the third vibration assembly is connected to at least one side of the vibration platform, and is used to drive the vibration platform to swing along a support shaft of the vibration platform to drive the test cylinder to swing.

11. The test device of claim 6, wherein the multi-stage vibration mechanism further comprises a third vibration assembly, the third vibration assembly is connected to at least one side of the vibration platform, and is used to drive the vibration platform to swing along a support shaft of the vibration platform to drive the test cylinder to swing.

12. The test device of claim 7, wherein the multi-stage vibration mechanism further comprises a third vibration assembly, the third vibration assembly is connected to at least one side of the vibration platform, and is used to drive the vibration platform to swing along a support shaft of the vibration platform to drive the test cylinder to swing.

13. The test device of claim 8, wherein the third vibration assembly comprises an extension shaft, a third vibration teeth-uncompleted gear, a vibration gear ring and a link, wherein the vibration gear ring is provided with a connector, one end of the link is hinged to the connector, and another end of the link is hinged to an outer wall of the vibration platform;
the extension shaft is connected to the rotary shaft, and both the extension shaft and the rotary shaft are suitable for moving in a vertical direction to be switchable between a first position and a second position;
in the first position, the third vibration teeth-uncompleted gear is completely disengaged from the vibration gear ring, the second rotary teeth-uncompleted gear is suitable for being engaged with the third transmission gear, and the first rotary teeth-uncompleted gear is suitable for being engaged with the first vibration bevel gear or the second vibration bevel gear; and
in the second position, the second rotary teeth-uncompleted gear is completely disengaged from the third transmission gear, the first rotary teeth-uncompleted gear is completely disengaged from the first vibration bevel gear and the second vibration bevel gear; and the third vibration teeth-uncompleted gear is engaged with the vibration gear ring.

14. The test device of claim 1, wherein the vibration platform comprises a first vibration body, a second vibration body and two support bodies;
a first vibration cavity is provided inside the first vibration body, a shape of the first vibration cavity is matched with a shape of the test cylinder, and the test cylinder is provided in the first vibration cavity;
a limit cavity is provided inside the second vibration body, a shape of the limit cavity is matched with a shape of the first vibration body, and the first vibration body is provided in the limit cavity; and both sides of the first vibration body are limited, and both sides of the first vibration body are suitable for reciprocally swing in the horizontal direction in the limit cavity; and
the two support bodies are symmetrically provided at opposite sides of the second vibration body, each support body is suitable for being fixed to a preset mount position, and the second vibration body is matched with each support body in a guiding manner, and is suitable for swinging along a support shaft of the support body.
